(19) United States
(12) Patent Application Publication
(10) Pub. No.: US 2010/0013211 A1
(43) Pub. Date: Jan. 21, 2010

(54) Identification tag

(76) Inventor: Syed Masood Ahmed, Canton, MI (US)

Correspondence Address: MASTROGIACOMO PLLC, 345 PINE STREET, WYANDOTTE, MI, 48192, US

(21) Appl. No.: 12/218,563

(22) Filed: Jul. 16, 2008

(51) Int. Cl. B42D 15/00

(52) U.S. Cl. 283/80

(57) ABSTRACT

An identification tag is provided that includes an elongate strip of flexible material having a top surface, a bottom surface, a first end and a second end. The identification tag further includes adhesive material and a label, the label being configured such that information may be added thereto. The strip of flexible material may be configured to wrap around about itself to produce a generally circular shape.

### CROSS REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON COMPACT DISC

Not Applicable

### BACKGROUND OF THE INVENTION

1. Field of the Invention

The present invention relates generally to identification tags and, more importantly, to identification tags that both disclose the identity of the owner of a particular piece of baggage and enable the owner to easily locate baggage, for example, on a baggage conveyor in an airport.

2. Background Art

Identification tags have been used to disclose information about the owner of baggage for a number of years. These tags are most helpful to identify the owner of the baggage if the baggage has been lost in an airport, train station, bus station or the like. Identification tags help to facilitate the quick return of the baggage to the owner.

Although identification tags have been used with baggage for a number of years, there are drawbacks that exist with the present designs. Often the tags in use today are the type that fastens to the baggage by some elastic, plastic, or gluing means. These tags are secured to the bags in such a way that the tags are left to dangle off the handle or zipper of the bag. While these tags may be secured to the baggage rather easily, they can be removed just as easily.

For instance, those individuals who travel by airplane must subject their baggage to numerous handling stations and often the bags travel long distances over conveyor systems. These handling stations and conveyor systems provide a number of opportunities for the tags to become caught or snagged and town away from the bags leaving the owner helpless to identify their bag or much worse, forever lose the bag if the bag is lost in any one of the transfers or sent on the wrong flight.

Another aspect of today's baggage is that many of the bags are indistinguishable. Often individuals rely solely on the identification tag to spot their bag on a baggage carousel at an airport. Individuals may also rely on a colorful ribbon or string that has been attached to the bag for positive identification, however, as with the identification tags, the ribbon or string can be easily torn away from the baggage.

Furthermore, the identification tags often used to identify baggage are many times subject to moisture and the elements. Luggage often will spend several minutes in the rain, snow, or thrown water from a puddle, while traveling from the plane to the luggage carousel. Identification tags subject to this moisture become unreadable and useless.

Therefore a need exists for an identification tag for use with baggage or luggage that provides an individual's personal information and provides a means for an individual to identify their baggage while at the same time being easy to attach to the bags without the chance that the tag could be torn away from the bag.

### BRIEF SUMMARY OF THE INVENTION

In accordance with the present invention, an identification tag is provided that includes an elongate strip of flexible material having a top surface, a bottom surface, a first end and a second end. The identification tag further includes an adhesive material and a label, the label being configured such that information may be added thereto. The strip of flexible material may be configured to wrap around about itself to produce a generally circular shape.

### BRIEF DESCRIPTION OF THE SEVERAL VIEWS OF THE DRAWINGS

The features and inventive aspects of the present invention will become more apparent from the following detailed description, claims, and drawings, of which the following is a brief description:

FIG. 1A is a perspective view of an identification tag according to an embodiment of the present invention shown attached to a piece of luggage;

FIG. 1B is an enlarged perspective view of an identification tag according to an embodiment of the present invention shown attached to a piece of luggage;

FIG. 2 is plan view of an identification tag according to the embodiment of the present invention;

FIG. 3 is a side elevation view of the identification tag according to an embodiment of the present invention;

FIG. 4 is a perspective view of the identification tag according to an embodiment of the present invention;

FIG. 5 is a side elevation view of the identification tag according to an embodiment of the present invention;

FIGS. 6A and 6B are side elevation views of the identification tag according to an embodiment of the present invention;

FIG. 7 is a perspective view of the identification tag according to another embodiment of the present invention;

FIG. 8 is a plan view of the identification tag according to an embodiment of the present invention;

FIG. 9 is a bottom view of the identification tag according to another embodiment of the present invention;

FIG. 10 is a plan view of the identification tag according to another embodiment of the present invention; and

FIG. 11 is a perspective view of the identification tag according to another embodiment of the present invention.

### DETAILED DESCRIPTION OF THE INVENTION

Referring now to the drawings, a preferred illustrative embodiment of the present invention is shown in detail. Although the drawings represent an embodiment of the present invention, the drawings are not necessarily to scale and certain features may be exaggerated to better illustrate and explain the present invention. Further, the embodiment set forth herein is not intended to be exhaustive or otherwise to limit or restrict the invention to the precise forms and configurations shown in the drawings and disclosed in the following detailed description.

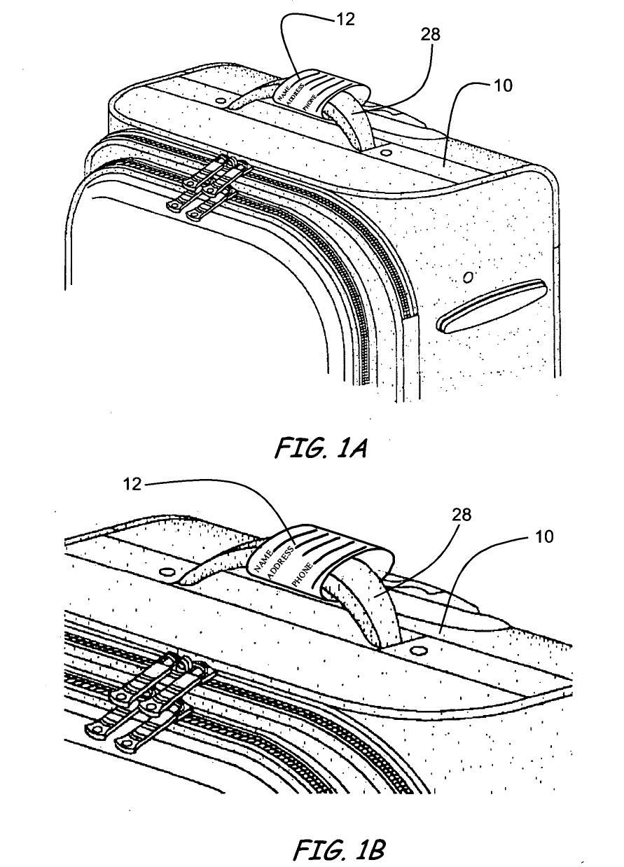

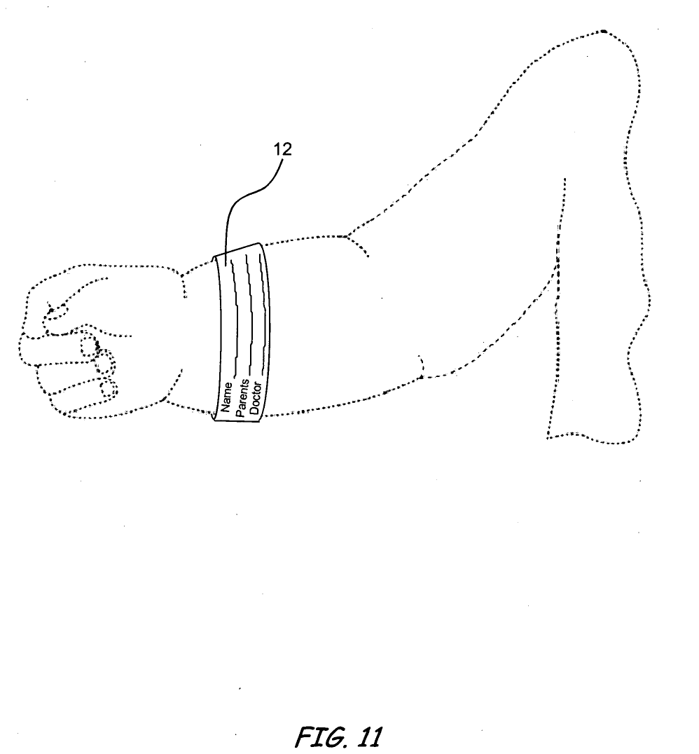

As depicted in FIGS. 1A and 1B, an identification tag 12 is shown attached and secured to a handle 28 of a suitcase 10 or any other type of luggage. In this particular embodiment, tag 12 may be configured in a manner and secured to suitcase 10 such that tag 12 may be easily readable and identifiable. Although identification tag 12 is illustrated with suitcase 10, it is important to note, however, that tag 12 may be used to identify any object, animal or individual, the suitcase or piece of baggage is used merely to illustrate one such possible application of the identification tag. Tag 12 may be easily secured to any arm or leg or arm of an animal or person (see e.g. FIG. 11).

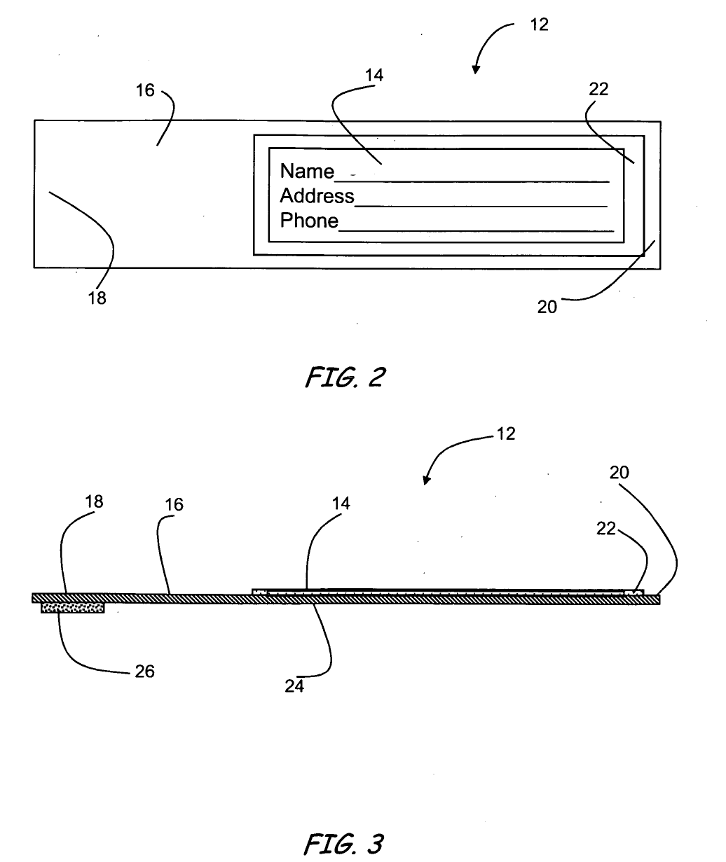

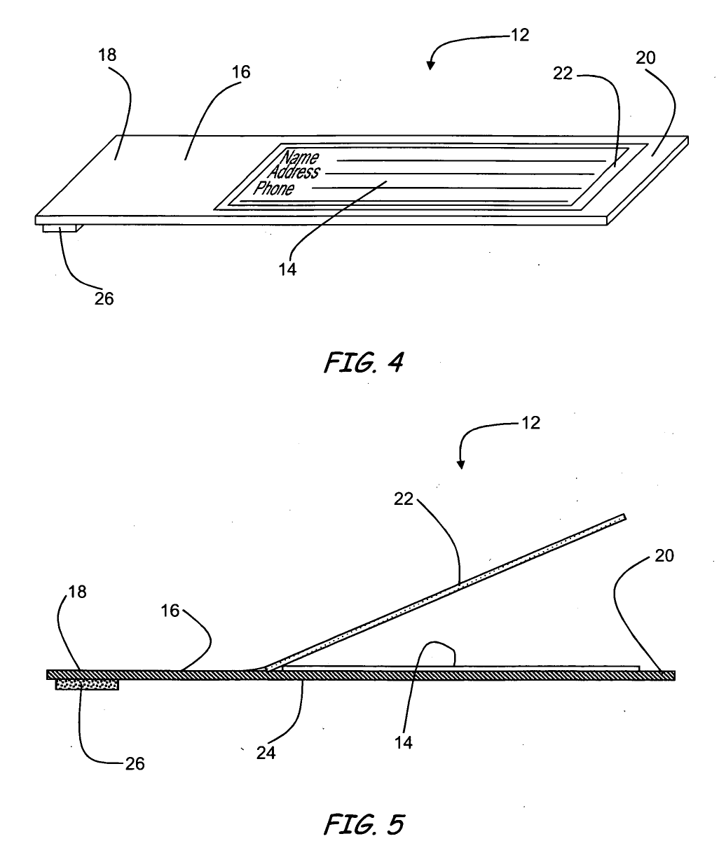

Referring now to FIGS. 2-5, in this particular embodiment, identification tag 12 includes a top surface 16, a first end 18, a second end 20, and a bottom surface 24. Top surface 16 includes a flap 22 for encasing an identification label 14. Bottom surface 24 includes an adhesive strip 26 that is shown positioned at first end 18. It is important to note, however, that the adhesive strip may be positioned at either first end 18 or second end 20 and may be positioned on top surface 16 or bottom surface 24, the choice of position in this particular embodiment is for illustrative purposes.

Label 14 includes an area for a user to enter identifying parameters pertaining to himself/herself such as NAME, ADDRESS, and PHONE NUMBER or the like. A user may either enter the information by hand with ink pen or pencil, or alternatively, label 14 may be configured in a manner such that the identifying parameters may be entered into a computer and printed directly onto label 14 by any printing media such as a laser jet printer, inkjet printer or the like.

Once the identifying parameters have been added to label 14, label 14 may then be secured to tag 12. As illustrated in FIG. 5, flap 22 may be raised from top surface 16 such that label 14 may be positioned under flap 22 and onto surface 16. After label 14 has been positioned onto surface 16, flap 22 may be lowered back onto surface 16 to secure label 14 to tag 12.

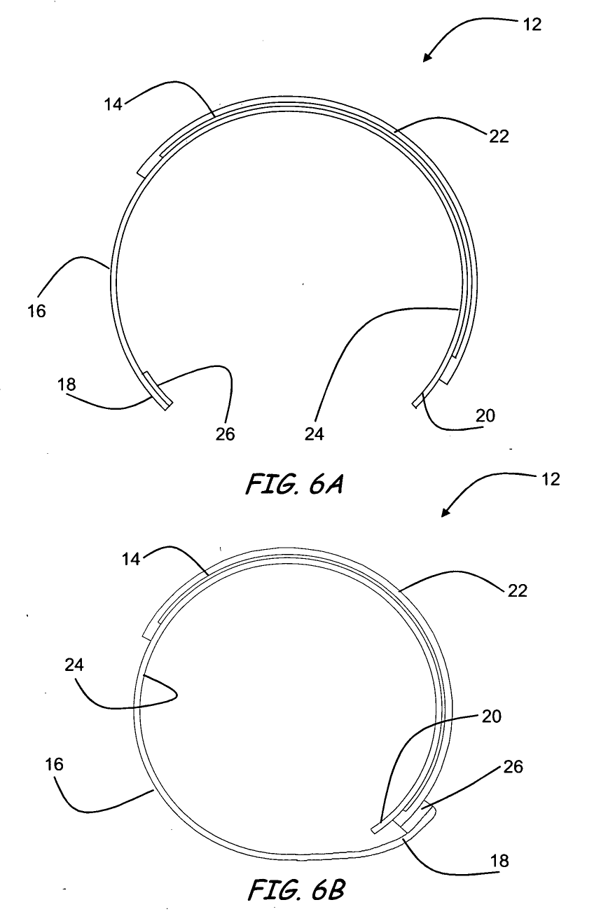

FIGS. 6A and 6B illustrate how tag 12 may be configured such that tag 12 may be secured around the handle of a piece of luggage, the arm or leg of an individual or animal, or any other object. Tag 12 may be folded upon itself such that a generally oval or round shape is produced when first end 18 meets second end 20. First end 18 continues to fold over second end 20 such that adhesive strip 26 of bottom surface 24 engages flap 22 of top surface 16. As adhesive strip 24 contacts flap 22 and top surface 16, adhesive strip 22 adheres to surface 16 and flap 22 to complete the generally rounded shape of tag 12. Furthermore, by securing flap 22 to surface 16 with adhesive strip 24, label 14 is now secured to tag 12. The adhesive used with adhesive strip 24 may be manufactured of any glue or adhesive material such that a strong bond may be maintained between first end 18 and second end 20 to maintain the generally rounded shape of tag 12 about the object, person or animal.

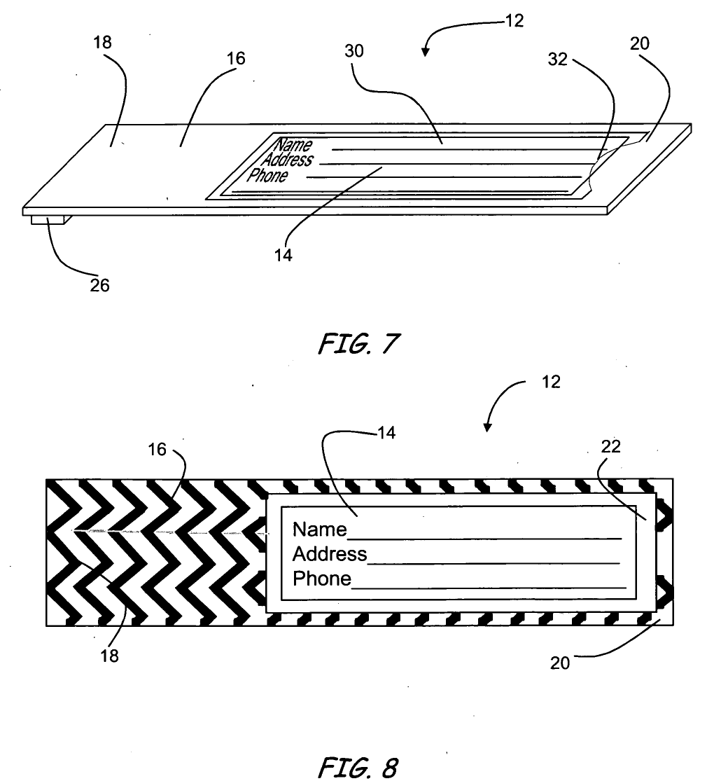

FIG. 7 illustrates another embodiment of the present invention. In this particular embodiment, a pocket 30 is used to capture label 14 to tag 12. A user, in much the same manner as described above, enters the identifying information onto label 14 and slides label 14 into pocket 30. As described above, first end 18 may be folded onto a pocket opening 32 at second end 20. Adhesive strip 26 engages top surface 16 to create a generally rounded shape and pocket opening 32 to close pocket opening 32 and seal pocket 30 to prevent label 14 from slipping out of tag 14.

Tag 12 may be manufactured of any type of plastic or vinyl materials such that tag 12 may maintain flexibility while protecting label 14 from water and any of the other elements that may damage label 14 if not for the protection of flap 22 or pocket 30 and tag 12. Tag 12 may also be manufactured of materials that are not easily torn, removed or destroyed to ensure that tag 12 remains intact and easily readable.

FIG. 8 illustrates one such manner where identification tag 12 may be manufactured in any design or colors to aid the user when trying to identify a piece of luggage on a luggage carousel at an airport, or for aiding to identify any object or individual. The particular pattern illustrated by FIG. 8 is that of a zigzag. It is important to note, however, that any type of identifying design, picture or colors may be used to improve the identifying aspect of tag 12.

Identification tags may be manufactured such that individual tags and labels are produced. Individual labels may be configured for writing information long hand, with a typewriter, or for use with a computer and in a printer such as a laser jet or ink jet. Alternatively, labels may be manufactured such that a number of labels may be included on one sheet of paper. For example, ten labels may be printed onto one 8.5″×11″ sheet of paper. It is important to note, however, that any size paper may be used to produce any number of labels. The sheet of paper may be configured to be used with a computer and any type of printer (laser jet, ink jet, etc.). Information may be entered into a computer and easily printed onto the labels. Other methods that may be used for producing labels may include using a computer to access a website on the World Wide Web to enter information and use a printer to prepare and print the label. Also, software to prepare labels may be provided on a compact disc or other storage medium for use with a computer. Information may be entered into a computer and easily printed onto the labels.

FIG. 9 illustrates yet another embodiment of the present invention. A microchip 34 may be added to tag 12. Microchip 34 may include the personal information of an individual. That information may include: NAME, ADDRESS, TELEPHONE NUMBER, FLIGHT INFORMATION, and the like. As discussed above, tag 12 may be used to identify individuals such as children (see e.g. FIG. 11) or animals, other information may be included in microchip 34 such as medical information and names of parent or owners. Microchip 34 is shown attached to bottom surface 24 in FIG. 9, however, it is important to note that microchip 34 will work equally as well if secured to top surface 16, or, alternatively, “sandwiched” between top surface 16 and bottom surface 24. In this particular embodiment of the present invention, airport employees or any other person, may use any type of scanner to read the information to check the information versus that information written or printed on the tag and/or the identification carried by the individual. This level of information may be used to ensure that baggage is not stolen from airports, shopping malls, etc. or lost and any unattended baggage may be quickly identified.

Alternatively, airport personnel may supply tags 12 and identification microchip 34 when a traveler presents their baggage for check in along with their personal identification (for instance driver's license or passport). Airport personnel may enter the information on the microchip/identification tag with a computer of the like and affix the tag to luggage. In this manner, airports will be able to ensure that the baggage is tagged with the correct identification for a particular individual. Thus making tracking and handling of the baggage easier at any point in the journey.

Tags 12 including microchip 34 may be especially useful because microchip 34 may have a readable range that may allow tag 12 to be secured on the interior of suitcase 10. Tag 12 with microchip 34 may be hidden and secured to the interior of bag 12 to aid in the preventing the theft of luggage from an airport, train station, bus depot or the like. Would be thieves would have a difficult time finding tag 12 on the inside of any luggage or not know tag 12 exists and may be deterred long enough for security and law enforcement to apprehend them or captured at a security checkpoint trying to leave the premises with a stolen piece of luggage.

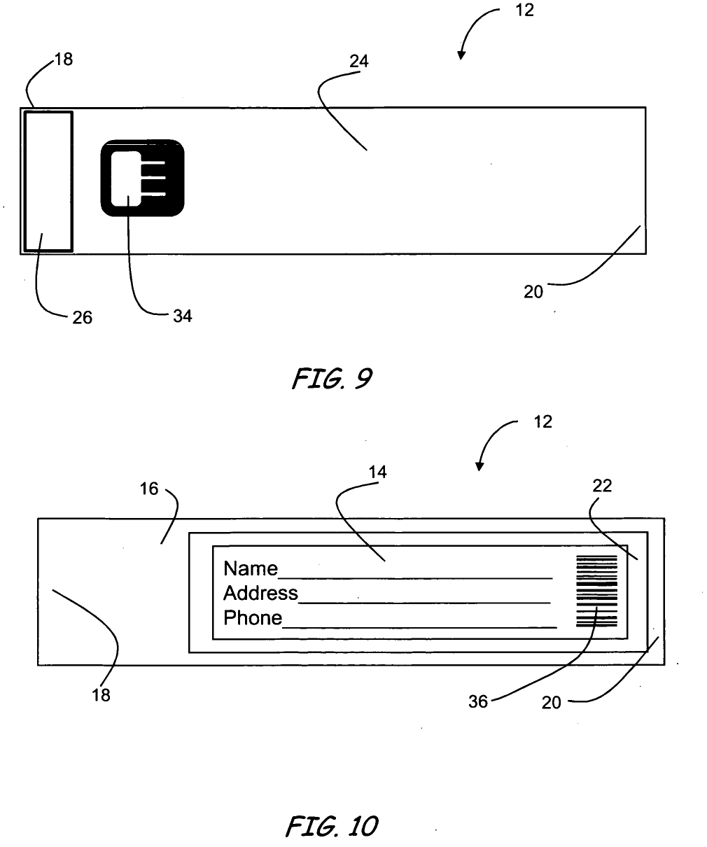

FIG. 10 illustrates still another embodiment of the present invention. In this particular embodiment, a bar code 36 may be included on label 14. Bar code 36 may include the following personal information: NAME, ADDRESS, TELEPHONE NUMBER, FLIGHT INFORMATION, and the like. As described above, labels 14 may be created on any computer and by using the World Wide Web to do so. This is especially useful today given that the World Wide Web is widely used to check in and print boarding passes for airline flights, bus travel, train travel, cruise ship travel or any means of travel requiring identification of the individual traveling. Labels 14 may be printed with boarding passes for travel and bar code 36 may include all the information contained in the boarding pass to identify the individual. For example, when using an online check in method prior to airline travel, labels 14 including bar code 36 may be printed with boarding passes. Bar code 36 may include all personal information for the individual as well as flight information such as time of flight, gate number, airlines, destination and the like. Labels 14 including bar code 36 may also be printed with boarding passes when printed at a check in desk or kiosk at the airport, bus depot, train station, dock and the like. Bar code 36 may be easily readable by any bar code reading device to identify the piece of luggage to ensure that the individual has his or her correct piece of baggage and to aid in preventing theft and abandon baggage.

The present invention has been particularly shown and described with reference to the foregoing embodiment, which is merely illustrative of the best modes presently known for carrying out the invention. It should be understood by those skilled in the art that various alternatives to the embodiment of the invention described herein may be employed in practicing the invention without departing from the spirit and scope of the invention as defined in the following claims. It is intended that the following claims define the scope of the invention and that the method within the scope of these claims and their equivalents by covered thereby. This description of the invention should be understood to include all novel and non-obvious combination of elements described herein, and claims may be presented in this or a later application to any novel non-obvious combination of these elements. Moreover, the foregoing embodiment is illustrative, and no single feature or element is essential to all possible combinations that may be claimed in this or a later application.

What is claimed is:

1. An identification tag comprising:
An elongate strip of flexible material having a top surface, a bottom surface, a first end and a second end;
an adhesive material;
a label, said label configured such that information may be added thereto; and
wherein said strip of flexible material is configured to wrap around about itself to produce a generally circular shape.

2. The identification tag as recited in claim 1, wherein said first end includes said adhesive material.

3. The identification tag as recited in claim 2, wherein said top surface includes a flap, said flap configured to capture and secure said label to said identification tag.

4. The identification tag as recited in claim 3, wherein said top surface further includes an adhesive for securing said flap to said top surface.

5. The identification tag as recited in claim 3, wherein said flap is secured to said top surface when said adhesive material of said first end contacts said top surface at said second end.

6. The identification tag as recited in claim 2, wherein said top surface includes a pocket, said pocket configured to capture and secure said label to said identification tag.

7. The identification tag as recited in claim 6, wherein said pocket includes a pocket opening, said pocket opening being closed when said adhesive material of said first end contacts said top surface at said second end.

8. The identification tag as recited in claim 1, wherein said tag further includes at least one color.

9. The identification tag as recited in claim 1, wherein said tag includes at least one design.

10. The identification tag as recited in claim 1, wherein said identification tag further includes a microchip encoded with information and easily readable by any device.

11. The identification tag as recited in claim 1, wherein said label includes a bar code encoded with information and easily readable by any device.

12. The identification tag as recited in claim 1, wherein said label may be configured to have information added thereto by a computer and printer.

13. The identification tag as recited in claim 1, wherein said identification tag is configured to be secured to luggage or a suitcase.

14. The identification tag as recited in claim 1, wherein said identification tag is configured to be secured to a person.

15. The identification tag as recited in claim 1, wherein said identification tag is configured to be secured to an animal.

16. An identification tag for luggage comprising:
An elongate strip of flexible material having a top surface, a bottom surface, a first end, said first end including an adhesive material, and a second end;
a label, said label configured such that information may be added thereto; and
wherein said strip of flexible material is configured to wrap around a handle of the luggage and secured to the handle when said adhesive material of said first end contacts said second end.

17. The identification tag as recited in claim 16, wherein said top surface includes a flap, said flap configured to capture and secure said label to said identification tag.

18. The identification tag as recited in claim 17, wherein said top surface further includes an adhesive for securing said flap to said top surface.

19. The identification tag as recited in claim 17, wherein said flap is secured to said top surface when said adhesive material of said first end contacts said top surface at said second end.

20. The identification tag as recited in claim 16, wherein said top surface includes a pocket, said pocket configured to capture and secure said label to said identification tag.

21. The identification tag as recited in claim 20, wherein said pocket includes a pocket opening, said pocket opening being closed when said adhesive material of said first end contacts said top surface at said second end.

22. The identification tag as recited in claim 16, wherein said tag further includes at least one color.

23. The identification tag as recited in claim 16, wherein said tag includes at least one design.

24. The identification tag as recited in claim 16, wherein said identification tag further includes a microchip encoded with information and easily readable by any device.

25. The identification tag as recited in claim 16, wherein said label includes a bar code encoded with information and easily readable by any device.

26. The identification tag as recited in claim 16, wherein said label may be configured to have information added thereto by a computer and printer.
